(19) United States
(12) Patent Application Publication
(10) Pub. No.: US 2006/0195370 A1
(43) Pub. Date: Aug. 31, 2006

(54) Inventory management method, system, and computer program

(75) Inventor: Christopher Howarth, London (GB)

Correspondence Address: KILYK & BOWERSOX, P.L.L.C., 3603 CHAIN BRIDGE ROAD, SUITE E, FAIRFAX, VA, 22030, US

(73) Assignee: SP Holdings Plc., London (GB)

(21) Appl. No.: 11/056,569

(22) Filed: Feb. 11, 2005

(51) Int. Cl. A01K 5/02; G06F 17/50

(52) U.S. Cl. 705/28; 705/29

(57) ABSTRACT

A method for identifying on-shelf availability of inventory items is provided. The method can comprise: collecting sales information comprising a Stock Keeping Unit (SKU), a sale date, and a sale quantity, from one or more sources; aggregating the sales information by calculating two or more measures comprising at least an expected sales quantity and an out-of-stock measure; completing a plurality of sales records from the aggregated sales information, the plurality of sales records corresponding to each inventory item by SKU, sale date, and source-identification; and storing the plurality of sales records. The method can comprise reporting the one or more fields of at least one of the plurality of sales records. A system and computer program code implementing a method, are also provided.

The present teachings relate to a method, system, and computer program for managing on-shelf availability of inventory items.

### SUMMARY

According to various embodiments, a method for identifying on-shelf availability of inventory items is provided. The method can comprise: collecting sales information comprising a Stock Keeping Unit (SKU), a sale date, and a sale quantity, from one or more sources; aggregating the sales information by calculating two or more measures comprising at least an expected sales quantity and an out-of-stock measure; completing a plurality of sales records from the aggregated sales information, the plurality of sales records corresponding to each inventory item by SKU, sale date, and source-identification; and storing the plurality of sales records. The method can comprise reporting the one or more fields of at least one of the plurality of sales records

According to various embodiments, a system for identifying on-shelf availability of inventory items is provided. The system can comprise: at least one information source module adapted to collect sales information comprising a Stock Keeping Unit (SKU), a sale date, and a sale quantity, from at least one source; a calculation module coupled to the at least one information source module and adapted to aggregate the sales information by calculating one or more measures comprising an expected sales quantity and an out-of-stock measure; a record composing unit coupled to the calculation module and adapted to complete a plurality of sales records from the aggregated sales information, the plurality of data records corresponding to each inventory item by SKU, sale date, and source-identification; and a data manager coupled to the record composing unit and adapted to store the plurality of sales records.

According to various embodiments, a computer program product for identifying on-shelf availability of inventory items is provided. The computer program product can comprise: computer code for collecting sales information comprising a Stock Keeping Unit (SKU), a sale date, and a sale quantity, from at least one source; computer code for aggregating the sales information by calculating one or more measures comprising an expected sales quantity and an out-of-stock measure; computer code for completing a plurality of sales records from the aggregated sales information, the plurality of data records corresponding to each inventory item by SKU, sale date, and source-id; and computer code for storing the plurality of sales records.

Additional features and advantages of the present teachings will be set forth in part in the description that follows, and in part will be apparent from the description, or may be learned by practice of the present teachings.

### BRIEF DESCRIPTION OF THE DRAWINGS

Various embodiments of the present teachings are exemplified in the accompanying drawings. The teachings are not limited to the embodiments depicted, and include equivalent structures and methods as set forth in the following description and as known to those of ordinary skill in the art. In the drawings:

FIG. 1 illustrates an embodiment of a system;

FIG. 2 is a process flow diagram of inventory management according to various embodiments;

FIG. 3 illustrates an embodiment of a dashboard-type GUI;

FIG. 4 illustrates an embodiment of a Report Builder Display;

FIG. 5 illustrates an embodiment of a Dimensions Explorer;

FIG. 6 illustrates an embodiment of a Report Viewer Explorer;

FIG. 7 depicts a flow chart of possible actions after an Out of Stock SKU has been identified by the teachings herein;

FIG. 8a, FIG. 8b, FIG. 8c, and FIG. 8d are exemplary results of comparing various measures in a control store versus a test store, each store operated by the same retailer; and

FIG. 9 is a formula of a measure.

It is to be understood that both the foregoing general description and the following detailed description are exemplary and explanatory only and are intended to provide a further explanation of various embodiments of the present teachings.

### DESCRIPTION OF VARIOUS EMBODIMENTS

Acronyms used in this application comprise Availability Management System (AMS), Fast Moving Consumer Goods (FMCG), Inactive Distribution Week (IDW), Lost Distribution Week (LDW), Stock Keeping Unit (an item sold in a shop), Short Term Offsale (STO), Zero Sales Day (ZSD), Lost Sales Value (LSV), Out Of Stock (OOS), and identification (id).

The term “stock keeping unit (SKU)” is an unique code, comprising letters and/or numbers, which can be assigned to a product by a manufacturer for purposes of identification and inventory control. The SKU can be a machine readable identifier, for example, an optical barcode or a Radio Frequency Identification (RFID) tag.

The term “manufacturer” refers to a distributor, reseller, retailer, or manufacturer of a SKU item.

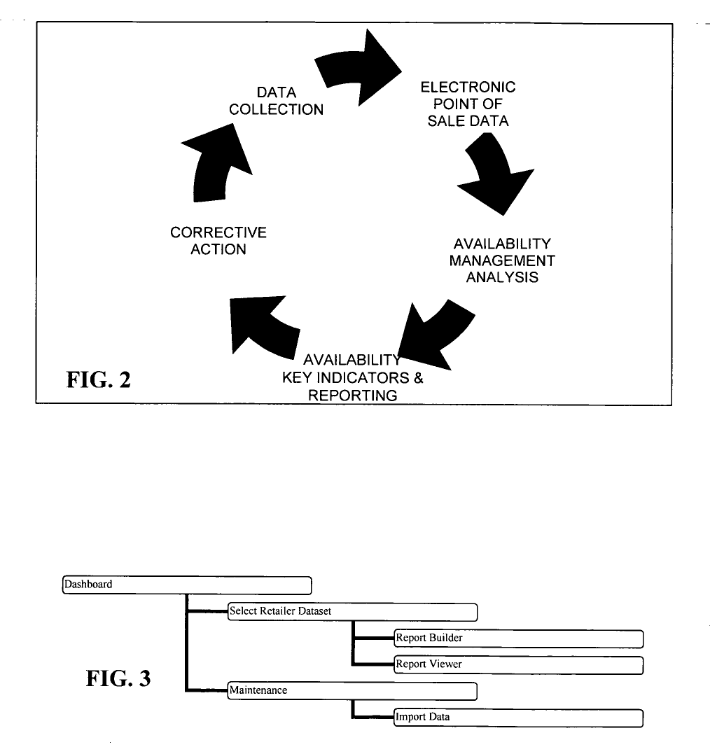

The teachings of the present application can be part of a continuum, a continuous process, which can deliver an improvement in on-shelf product availability. The improvement can be measurable. The teachings can be used by retailers and manufacturers. As illustrated in FIG. 2, inventory management starts with data collection. The data can be integrated with sales activity data and can comprise, for example, Electronic Point of Sale (EPOS) data. The sales activity data can be stored as sales records. The inventory management analysis in accordance with the teachings of the present application can be used to identifying inventory items using a defined set of key indicator measures, with on shelf availability issues, for example, where there has probably not been enough product on shelf to satisfy shopper demand and maximise manufacturer and retailer sales. The inventory items can use a Stock-Keeping Unit (SKU) to item identification. The measures reported by the inventory management analysis can be used to direct corrective actions, for example, by a retailer at a store level. Data collection after the corrective actions have been taken can, for example, verify the accuracy of the corrective actions, verify the necessity of the corrective actions, or identify incorrect inventory information in the EPOS data.

According to various embodiments, the results of the teachings can be measured by comparing the sales performance of SKU/store, a test group, combinations where corrective action has been taken against a control group of stores where no action has been taken. An ongoing analysis of the test and control group performance versus a pre-project base period can be performed. The ongoing analysis can also measure test group performance versus control group performance.

According to various embodiments, to facilitate the inventory management analysis reports can be outputs, for example, form reports reporting problem SKUs for each store can be produced. These reports can be used in a store by a field marketing resource to rectify the root causes of the inventory availability problem.

According to various embodiments, the teachings of the present application can be implemented using a database, for example, a relational database management system, for example, Oracle available from Oracle Corporation of Redwood Shores, Calif., or SQL-Server available from Microsoft Corporation of Redmond, Wash.

According to various embodiments, a data management and integration tool, for example, CRUNCH technology available from Decisions Made Easy of Rogers, Ark., can be used to create all the data tables, and provide data management functions including imports, meta data management and caching calculations and aggregate data, known as cube creation under CRUNCH. This can eliminate summary tables, limitations on the number of aggregates and complex procedures to restate historical data when characteristics change. See http://www.toplinedata.com/product_service/crunch.htm for information about CRUNCH.

According to various embodiments, a data post-processing module, for example, CIPHER technology available from Decisions Made Easy of Rogers, Ark., can be used for fast “on the fly” processing of a huge range of metrics and aggregates. The indexing within these can be specifically designed to perform such tasks. Reports can be easily created and saved using a range of functions and filters. Reporting formats can include integration into various MS Office products available from Microsoft Corporation of Redmond, Wash. See http://www.toplinedata.com/product_service/cipher.htm for information about CIPHER.

According to various embodiments, software implementing the teachings of the present application is available as Availability Management System (AMS) from SP Holdings Plc, 3-5 Rathbone Place, London W1T 1HJ. AMS uses CRUNCH and CIPHER technology to build a database of EPOS sales for every SKU, in every store, on every day. Daily sales for each SKU in each store can then examined to identify SKUs that meet a sales pattern.

According to various embodiments, the lost sales value of each Out of Stock can be calculated, enabling an Out of Stock % to be calculated for every SKU in each store. Store-specific reports can be used to identify issues SKUs in each store, together with the level of lost sales for each SKU. Issue SKUs can be root-cause analysed at a store level, for example, via a third party merchandising agency.

### Exemplary System Configuration

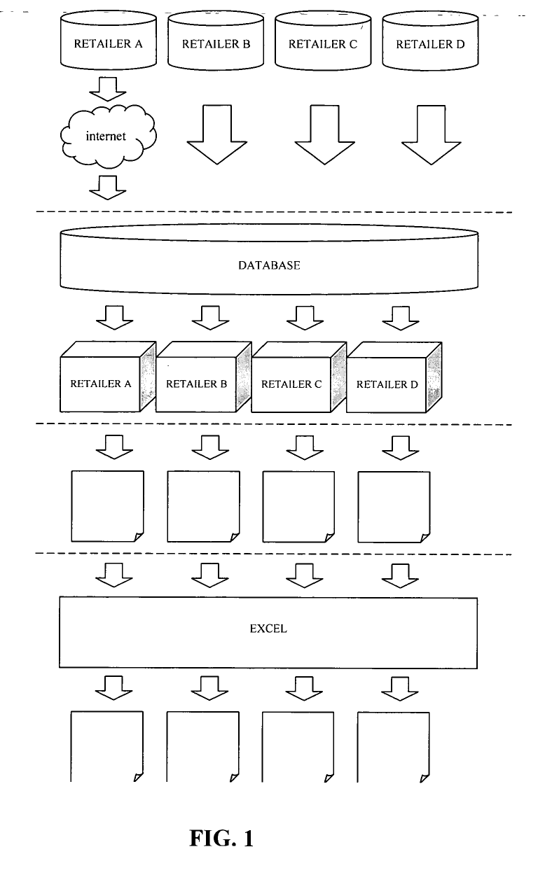

According to various embodiments, FIG. 1 illustrates an embodiment of a system capable of implementing the teachings herein. A retailer dataset 102, possibly all in different formats, can be retrieved 104 and loaded into a database 106 where a predefined catalog, one per dataset, can be used to map fields, change formats, etc of the incoming retailer data. Frequency of data retrieval can be dependent on availability of data. For example, data retrieval and data load can be on a weekly or monthly schedule. This can allow for staggered retrieval and loading of retailer data to manage limited resources. Data can be retrieved by, for example, electronic transmission, network transmission, media exchange using tapes, compact disks (CD), data video disks (DVD).

According to various embodiments, the database 106 can comprise a RDBMS, for example, SQL Server or Oracle. Programming code can be used to output a series of caches or cubes 108, for example, one cube per retailer dataset 102. A front end 110 provided by the RDBMS manufacturer or a third party report generator can be used to interrogate data and format reports. The reports can be output in paper or electronic media. The report can be formatted to allow for easy insertion, tabulation, assimilation, and integration by third party tools 112, for example, reports can be copied and pasted into a tabular data manipulation tool, for example, MS Excel. The reports can be massaged by the third party tools to create end user reports 114. The end-user reports 114 can include further calculations and can comprise tables, charts, graphs, or other visual presentations known in the art. The end-user reports 114 can compress data for easier human comprehension.

Reports and calculations can be built in or supplied as macros, functions etc. and as such can be created manually in Excel. The cached aggregated data, in the cubes, can be manipulated relatively quickly given the amount of data they hold. The cached aggregated data can be compressed. The cached aggregated data can facilitate portability across different computer systems or platforms.

### Dashboard

According to various embodiments, the system can comprise a user or graphical interface (GUI). The graphical interface can allow for navigation through the various reports via a dashboard-type GUI. An embodiment of a dashboard-type GUI is shown in FIG. 3. Different function provided by the system can be accessible by the dashboard-type GUI. The GUI can comprise an input subsystem adapted to accept input using, for example, dialog boxes, buttons, cut and paste buffers, or other means well known in the art.

### Report Builder

According to various embodiments, the system can comprise a Report Builder that can be used to generate and format a report. The report builder can allow for customization of reports produced by the system. A user can create desired reports or modify existing reports. The report builder can provide a graphical interface and can comprise the following steps to build a report:
Use a Report Field Selector for selecting the fields to be displayed
Use a Report Layout Display to setup a report layout
Enter report selection criteria
Choose output format, for example, Excel, grid, or chart.
Use a Report Viewer Explorer to view the report.

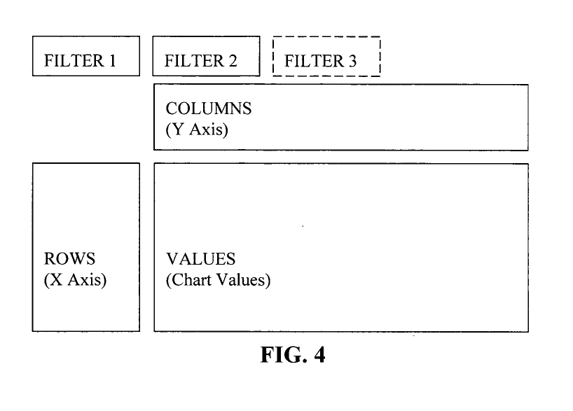

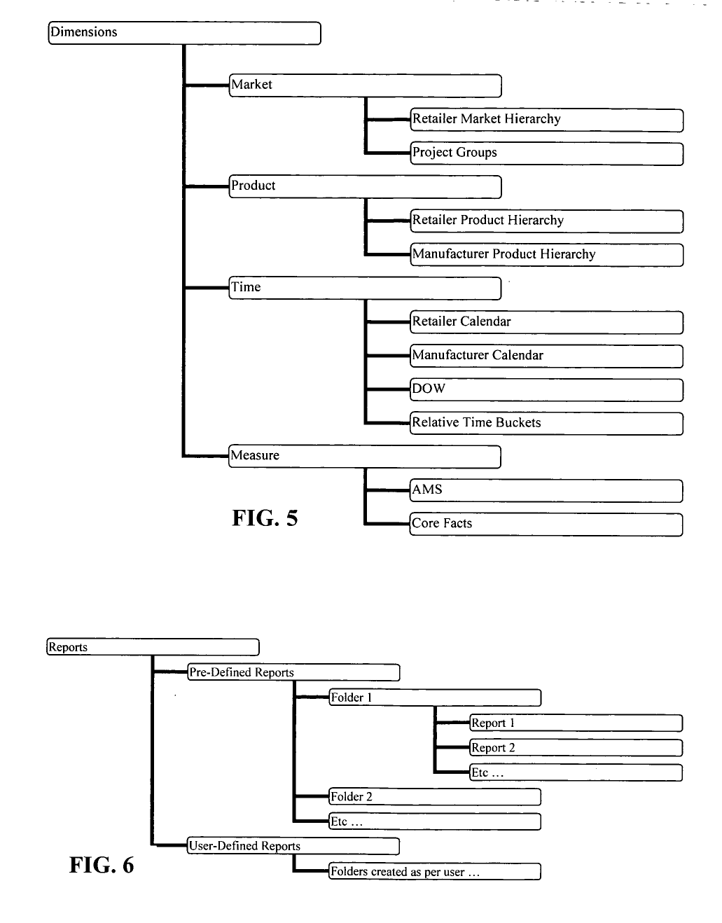

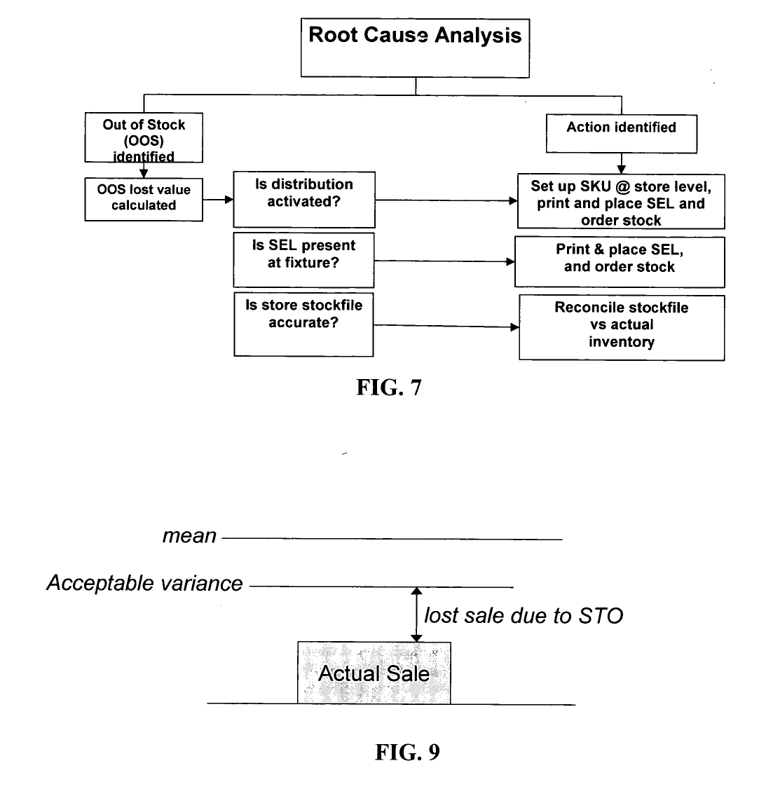

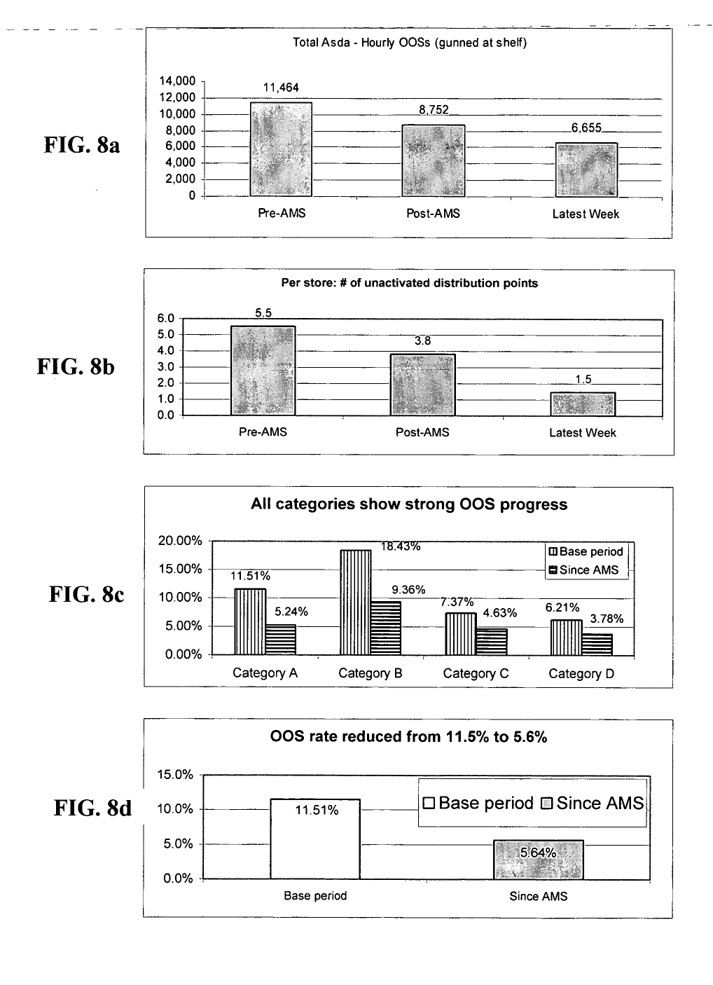

FIG. 5 illustrates an embodiment of a Dimension Explorer that can be used to view a schema, tables, fields and aggregates of a dataset, possibly in a cube. The Report Builder can enable a user to select from different levels within the dimension explorer, and drag and drop fields from the Dimension Explorer onto the Report Layout Display, see FIG. 4.

FIG. 4 illustrates an embodiment of a Report Builder Display. Fields can be dropped into various sections of the report layout display. If multiple fields are dropped into any area, the order in which they sit can determine the report nesting.

A Report Selection Criteria can be attached to the report so far composed. The Report Selection Criteria can comprise predicates, for example, predicates defined in various SQL standards using the “WHERE”, “FOR”, “HAVING”, or other key words known in the art.

A Report Calculation Builder can be the final building block of defining a user-defined report. The Report Calculation Builder can add user friendly touches to the user-defined report, for example, by giving it a name, building or compiling it, keeping to current report, or add to measures. Any or all of these final steps can be restricted to administrators.

FIG. 6 illustrates an embodiment of a Report Viewer Explorer. The report viewer explorer can allow a user to select pre-defined, user-defined, or previously saved reports. Users can view, print, e-mail, copy and paste the contents of reports as they choose. Pre-defined reports cannot be edited. However, they can be saved as something else within the user-defined reports folder. Users can easily navigate back to the report viewer browser at any time.

A user with administrator access can have full read write access to the pre-defined reports structure. For example, new reports can be added, new folders can be created, existing reports can be, for example, edited, moved, or deleted.

### Dataset Schema

A typical set of retailer data includes some reference and some transactional data. In addition to retailer data, some manufacturer reference data can be maintained. An exemplary EPOS schema describing can comprise the following tables and fields.
Reference Data—From a Retailer
   Stores (Market): Store id, Store name, Store format, Store region, Store address (several fields), and Square footage.
   Products: Product id, Product description, Product variety, Product size, Category id, Sub-category id, Sub-sub-category id, Supplier id, RSP, Retailer margin, sales tax rate, and Barcode.
   Suppliers (Manufacturers): Supplier id and Supplier name.
   Ranging Data: Store id, Product id, Ranged flag, Ranged from date, Ranged to date, and Max shelf.
Reference Data—from manufacturer
   Products: Product id, Retailer product id, Product description, Product variety, Product size, Category id, Sub-category id, Sub-sub-category id, and Manufacturer margin.
Other Reference Data
   Stores: Store id and Project group.
   Calendar: Date, DOW, Retailer week, and Manufacturer week.
   Project Base Period: Retailer id, Base period start date, and Base period end date.
   Field Agent Store: Agency ID, Agent ID, Agent name, Store ID, and Retailer ID.
   Retail Week: Retailer ID and Week Start DOW.
Transactional Data—from retailer
   Sales Transactions: Store id, Product id, Date, Sales qty, and Sales value.
   Offsales: Product id, Store id, and Offsale date.

### Measures

The following measures sit within a standard folder structure which can be consistent across retailer cubes and clients. Only measures which can be applicable to a given retailer dataset can be included in a related cube.

The term “Permanent Out of Stocks” as used herein refers to SKUs that can be ranged or targeted for distribution in a store, a particular store, but which SKUs do not have any sales history in the store. The term can refer to SKUs that have never been activated in the store.

The number of stores where distribution of a SKU has been agreed but not activated, or the permanent out of stocks, represents a major incremental distribution opportunity for manufacturers.

The term “Permanent Out of Stocks-Lost Value Sales” as used herein refers to the number of stores which have inactivated distribution on each SKU multiplied by average weekly value sales for that SKU. For example, two stores can be ranged for SKU A and the stores have no sales history. The average weekly value rate of sale per store for SKU A can be $42.00. Total weekly lost value sales can be therefore $84.00 ($42.00 per store×2 stores).

The term “Daily Out of Stocks” as used herein refers to the number of store/day instances where a particular SKU sells zero units in a day. For example, SKU A has 60 daily Out of Stocks in Store S1 for Retailer in a given week. The daily out of stocks may consist of one (1) day off sale in 60 different stores, or two (2) days off sale in 30 stores, or three (3) days off sale in 20 stores etc. Note, where average rate of sale is, for example, below 15 units per week, zero sales in a day does not necessarily indicate an out-of-stock. According to various embodiments, in cases of a daily rate of sale below 15 units per week, consecutive days of zero sales can be used to identify out-of-stocks.

The term “Daily Out of Stocks-Lost Value Sales” as used herein refers to Each individual day of zero sales multiplied by average daily rate of sale in that store. For example, SKU A registers zero daily sales on Thursday in Store S1 for Retailer. SKU A average sales value on a Thursday in Store S1 for Retailer can be $25.00. Lost value sales in Store S1 for Retailer R1 are therefore $25.00. Lost value sales in all stores can be compiled to calculate total rate of lost value sales from Daily Out of Stocks

The term “Hourly Out of Stocks” as used herein refers to the number of store/day instances where a SKU sells less than 50% of the expected rate of sale. Expected rate of sale can be calculated on a daily, store-level basis from 52 weeks historical data, for example, SKU A average value sales on a Thursday (across the previous 52 weeks) in Store S1 for Retailer R1 can be $25.00. Where SKU A sells less than $12.50 on a Thursday in Store S1 for Retailer R1 this indicates an Hourly Out of Stock.

The term “Hourly Out of Stocks-Lost Value Sales” as used herein refers to For each individual Hourly Out of Stock, the difference between Actual Sales and Expected Sales can be calculated. For example, SKU A Expected Sales for Thursday in Store S1 Retailer R1 can be $25.00. Actual Sales can be $5.00; less than 50% of Expected Sales. Lost Value Sales can be the difference between Expected Sales and Actual Sales, $25.00−$5.00=$20.00. Lost Value Sales can be therefore $20.00.

The term “Total Value Sales at Risk” as used herein refers to lost Value Sales from Permanent Out of Stocks, Daily Out of Stocks and Hourly Out of Stocks added together to establish a Total Value Sales at Risk. This can be the value of all occasions where a consumer walks to the fixture intending to purchase SKU A, and finds SKU A to be Out of Stock.

The term “Lost Sale Percentage” as used herein refers to the percentage of Out of Stocks which translate into lost sales. This can vary by brand and category. For example, an Out of Stock in an impulse category can result in a lost sale more frequently than an Out of Stock in a fixed-consumption category with multiple switching options (brand/size/variant). Lost Sale Percentage identifies what proportion of Out of Stocks translates into lost sales. For example, Lost Sale Percentage can be calculated by identifying ten occasions where SKU A sold zero units in a given day in a given store. Expected vs. actual sales can be compared for all other SKUs in the brand to identify how many consumes switched into other variants while SKU A was Out of Stock. For example, SKU A sold zero units in Store S1 Retailer R1 on Thursday. SKU A expected rate of sale was 25 units. SKU B sales on Thursday in Store S1 Retailer R1 were 35 units versus expected sales of 30 units, or +5 units versus the expected; and SKU C sales were 40 units versus expected sales of 30 units, or +10 units over the expected. SKU A Lost Sales was therefore 25 units, expected 25 minus actual 0.15 units of Lost Sales were switched into SKU B (Expected 30, Actual 35) and SKU C (Expected 30, Actual 40). SKU A True Lost Sales is therefore 10 units, Total Lost Sales (25) minus Switched into other SKUs (15).

The term “Lost Sales Percentage” as used herein refers to True Lost Sales divided by Total Lost Sales, for example, 10 units divided by 25 units, or 40%.

The term “Total Value Sales Lost” as used herein refers to the true level of sales loss from Out of Stocks. Total Value Sales Lost can be Total Value Sales at Risk multiplied by Lost Sales Percentage. For example, SKU A Total Value Sales at Risk can be $10,000. SKU A Lost Sales Percentage can be 40%. Total Value Sales Lost can be therefore $4,000 ($10,000×40%).

The term “Out of Stock %” as used herein refers to Total Value Sales at Risk divided by Total Sales Value, for example, SKU A Total Value Sales at Risk can be $10,000; SKU A Total Sales Value per week can be $100,000; SKU A Out of Stock % can be therefore 10.0% ($10,000 divided by $00,000).

### Component Measures

The following measures can be component parts in other measures, but can also be used separately.

This Average Daily Sales Value can be calculated differently depending on the amount of history available. All averages can be based on the day of the week. Zero sales days can be excluded to prevent the average being pulled down. For 12 or less weeks, this can be a fixed average which can be calculated for weeks 1 to 12. For example, all Monday averages can be the same, all Tuesday averages can be the same, etc. Every dataset can have a fixed average for the first 12 weeks. For 13 to 52 weeks, this can be a cumulative average. For example, week 13 averages can be based on the previous 12 weeks; week 14 can be based on the previous 13 weeks, etc. For 53+ weeks, this can be a rolling average which can be calculated over the sales history up to a maximum of 1 year or 52 instances. This measure can be unpopulated at the weekly level.

The Average Daily Sales Volume can be expressed as a units volume, this measure uses the same method as the Average Daily Sales Value.

Count Of Weeks Averaged can be a count of the number of days or weeks over which the average is calculated.

Average Weekly Sales Value can be calculated differently depending on the amount of history available. Zero sales days can be excluded to prevent the average being pulled down. For 12 or less weeks this can be a fixed average which can be calculated for weeks 1 to 12. Every dataset can have a fixed average for the first 12 weeks. For 13 to 52 weeks, this can be a cumulative average. For example, week 13 averages can be based on the previous 12 weeks; week 14 can be based on the previous 13 weeks, etc. For 53+ weeks, this can be a rolling average which can be calculated over the sales history up to a maximum of 1 year (i.e. 52 instances). This measure can be unpopulated at the daily level.

An Average Weekly Sales Volume can be expressed as a units volume; this measure uses the same method as Average Weekly Sales Value.

Mean−x% Value

Mean−x% Volume

The Standard Deviation Value is a rolling standard deviation based on the day of the week. For any given day the standard deviation can be calculated back, based on values for that day only, over the entire sales history up to a maximum of 1 year (i.e. 52 instances). Expressed as a $ value, the calculation for this is:
\sqrt{Σ(x−□)²/(n−1)}
Where x=the mean daily average, □=the sample value, and n=sample size.

Note: Zero Sale Days (ZSD)s can be excluded from the calculation—this assumes that each store should sell at least one of each ranged SKU everyday. If there is less than 12 weeks sales history, the standard deviation does not roll. Instead a fixed standard deviation can be calculated for the entire history available from that point backwards, or all standard deviations can be the same. Every dataset can have a fixed standard deviation for the first 12 weeks. From the 13^{th} week onwards the standard deviation can be cumulative. This measure can be unpopulated at the weekly level.

A Standard Deviation Volume can be expressed as a units volume. This measure uses the same method as Mean−x% Value.

A Base Value Sales can be expressed as a $value, which can be calculated as:
Σ(Base period sales value)/number of weeks in base period

A Base Volume Sales can be expressed as a units volume, which can be calculated using the same method as Base Value Sale.

### Inactive Distribution

These measures can be based on the store/SKU ranging relationship. They identify ranged SKUs that have never sold in stores for which they are ranged.

The Count of Inactive Distribution Weeks (scan gaps)—without ranging data measure returns Store/SKU combinations where:
SKU has sold at least one unit per week in at least 10% of the total test+control stores over the last 4 full weeks, starting at current week−1
SKU total value sales over entire history=0
On the store/SKU level this can be a weekly Boolean measure and as such can be unpopulated at the daily level.

The Count of Inactive Distribution Weeks (scan gaps)—with ranging data measure is a weekly Boolean measure on the store/SKU level and as such can be unpopulated at the daily level. It returns Store/SKU combinations where:
SKU can be ranged to store
SKU total value sales over entire history=0

The Lost Sales Value due to Inactive Distribution measure is a calculation that can be expressed as a $ value for stores which meet the criteria for the Count of Inactive Distribution Weeks (scan gaps)—with ranging data measure. The calculation can be as follows:
Count of inactive Distribution Weeks*Average Weekly Sales Value^{t}

The Lost Sales Volume due to Inactive Distribution can be expressed as a units volume. This measure can be calculated using the same method as the Lost Sales Value due to Inactive Distribution measure.

### Lost Distribution

The Lost Distribution measures evaluate where a ranged SKU has sold but is no longer selling in a given store.

The Count of Lost Distribution Weeks—without ranging data measure is a weekly Boolean measure on the store/SKU level and as such can be unpopulated at the daily level. It returns Store/SKU combinations where:
SKU has sold at least one unit per week in at least 10% of the total test+control stores over the last 4 full weeks, starting at current week−1
SKU sales value of SKU=>1 per week
SKU total sales value over last 14 days=0

The Count of Lost Distribution Weeks—with ranging data measure returns Store/SKU combinations where:
SKU can be ranged to store
SKU sales value of SKU=>1 per week
SKU total sales value over last 14 days=0
On the store/SKU level this can be a weekly Boolean measure and as such can be unpopulated at the daily level.

The Lost Sales Value due to Lost Distribution measure is a calculation that can be expressed as a $ value for stores which meet the criteria for The Count of Lost Distribution Weeks—with ranging data measure. The calculation can be as follows:
Count of Lost Distribution Weeks*Average Weekly Sales Value^{t}

The Lost Sales Volume due to Inactive Distribution can be expressed as a units volume. This measure can be calculated using the same method as the Lost Sales Value due to Inactive Distribution measure.

### Short Term Offsales

A store/SKU/day short term offsale (STO) measures are measures where actual sales are less than average sales minus the variance. This type of calculation can be illustrated in FIG. 9. In FIG. 9 average sales can be indicated by the mean line. The STO measures can be pertinent to empty shelves in a store, for example, if a store employee scans a shelf where items for a SKU should be present and the shelf is empty, these are gunned offsales. They STO measures can be indicative of discrepancies in the number of items in an inventory database and actual product in-store. The STO measures can be indicated by:
A gunned offsale in a store, and/or
Lower than expected sales

A Daily Gunned Offsale Flag measure is a Boolean measure by store/SKU/day. The weekly level value for this measure equals the sum of the day level values within that week, for example, maximum per SKU/store=7.

The Count of Short Term Offsales (Ungunned) is a Boolean measure of store/SKU/day combinations where actual sales can be less than average sales minus the variance. The weekly level value for this measure equals the sum of the day level values within that week.

The Lost Sales Value due to Short Term Offsales (Ungunned) measure can be expressed as a $ value, the calculation for this is:
(average daily sales−variance)−actual daily sales
WHERE actual<average AND (average−actual)>variance OR
WHERE Count of Short Term Offsales (Ungunned)=True

The Lost Sales Volume due to Short Term Offsales (Ungunned) measure uses the same method as the Lost Sales Value due to Short Term Offsales (Ungunned) measure.

### Zero Sales Days

The Count of ZSDs is a store/SKU/day level count of days where sales quantity<1. Store/SKU combinations returned for inactive distribution and lost distribution can be excluded.

The Lost Sales Value due to ZSDs can be expressed as a $ value, this is calculated as follows:
Count of ZSDs*Average Daily Sales

The Equivalent Stores (ZSD) can be expressed as a number of stores per SKU, this is calculated as follows:
Count of ZSDs/number of days

### Lost Sales Opportunity

The Total Lost Sales Opportunity Value measure can be expressed as a $ value, the calculation for this is:
ID LSV+LD LSV+STO LSV+ZSD LSV

The Total Lost Sales Opportunity Volume measure can be expressed as a units value, the calculation for the same as the Total Lost Sales Opportunity Value measure.

### Other Summary Measures

The Sales Lost (OOS%) measure can be calculated as:
(lost sales/(actual sales+lost sales))*100

The Incremental Sales Value Versus Base Period measure can be expressed as a weekly $ value, the calculation for this is:
(weekly sales value/(base period sales value/# weeks in base period

### Reports

According to various embodiments, a system can include user-defined and system-defined reports. Both types of reports can be customized for a particular customer of a system manufactured according to the teachings herein. A report can comprise a subset of measures defined herein. The reported measures can be manipulated prior to reporting. The measures can be, for example, aggregated, grouped, nested, summarized, and/or reported in a tabular format. The reports can be, for example, detailed reports, summary reports, store specific, brand specific, category specific, illustrate relative significance of indicators, illustrate Cumulative Opportunity by SKU (%), illustrate Cumulative Value By Store, illustrate Incremental Value Sales (%), illustrate Duration of OOS, or illustrate OOS by DOW.

The report can comprise Test group only data, control group data, or any combination thereof. The report can be a Bar chart, Line graph, PIE chart, horizontal bar, or graphical means known in the art. The report can report values, percentages, deviations, or other measures. The report can comprise sales records for less than about half a day, from about half a day to about one day, from about one day to about three days, from about 3 days to about seven days, from about one month to about three months, about one year, or more than about one year.

According to various embodiments, a method for identifying on-shelf availability of inventory items is provided. The method can comprise: collecting sales information comprising a Stock Keeping Unit (SKU), a sale date, and a sale quantity, from one or more sources; aggregating the sales information by calculating two or more measures comprising at least an expected sales quantity and an out-of-stock measure; completing a plurality of sales records from the aggregated sales information, the plurality of sales records corresponding to each inventory item by SKU, sale date, and source-identification; and storing the plurality of sales records. The method can comprise reporting the one or more fields of at least one of the plurality of sales records

According to various embodiments, aggregating the sales information by calculating the two or more measures can comprise computing at least one of a fixed average, a cumulative average, and a rolling average, based on a time period for which transactional history data can be provided by the plurality of sales records. Aggregating the sales information by calculating the two or more measures can comprise computing a standard deviation based on a day of the week for a time period for which transactional history data can be provided by the plurality of sales records. The standard deviation (A) can be computed by the formula:
Δ=\sqrt{Σ(x−□)²/(n−1)}

where x is a mean daily average, □ is a sample value, and n is a sample size.

According to various embodiments, the plurality of sales records can comprise sales records for 12 weeks or less, from about 13 weeks to about 52 weeks, more than about 52 weeks, a year, a quarter of a year, a half of a year, a month, a time period defining a holiday season.

According to various embodiments, each of the plurality of sales records can comprise two or more fields and the method can comprise reporting at least one of the plurality of sales records. The one or more fields can comprise at least one of a sale store-identification, an inventory item manufacturer, an inventory item brand, an inventory item category, an inventory item sub-category, an inventory item sub-sub-category, an inventory item supplier identification, an inventory item brand, an inventory item brand, an inventory item brand, or a combination thereof. The reporting can comprise using a graphical representation of the one or more fields to formulate a report. The graphical representation can comprise at least one of a block, an icon, a connector, or a combination thereof. The reporting can comprise summarizing a subset of the plurality of sales records by aggregating the subset of the plurality of sales record across at least one of the one or more fields. The reporting can comprise sorting a subset of the plurality of sales records across at least one of the one or more fields.

According to various embodiments, storing the plurality of records can comprise storing a plurality of transactional records in one or more first set of tables of a database and storing a plurality of reference records in one or more second set of tables of the database. Each of the plurality of transactional records can comprise one or more transaction fields. Each of the plurality of reference records can comprise one or more reference fields. The method can comprise forming a joint table by obtaining cross-multiplication product of the plurality of transactional records and the plurality of reference records, and reporting one or more joint table fields of the joint table.

According to various embodiments, the one or more sources can comprise a manufacturer, a plurality of distribution channels for a manufacturer, a store, a plurality of stores under an umbrella organization, a plurality of stores under a plurality of umbrella organizations, a brand, a plurality of brands, or a combination thereof.

According to various embodiments, the method can comprise managing on-shelf availability of inventory items according to the one or more measures for at least one of the one or more sources. The managing can comprise at least one of performing a root-cause analysis, identifying a SKU specific issue, augmenting inventory of a SKU, recounting inventory of a SKU, adjusting shelf-space of a SKU, or a combination thereof.

According to various embodiments, the method can comprise comparing inventory items sales performance of a test store against a control store wherein the control store comprises a store where no corrective action based on for identifying on-shelf availability of inventory items has been taken and the test store comprises a store where corrective action based on for identifying on-shelf availability of inventory items has been taken.

According to various embodiments, a system for identifying on-shelf availability of inventory items is provided. The system can comprise: at least one information source module adapted to collect sales information comprising a Stock Keeping Unit (SKU), a sale date, and a sale quantity, from at least one source; a calculation module coupled to the at least one information source module and adapted to aggregate the sales information by calculating one or more measures comprising an expected sales quantity and an out-of-stock measure; a record composing unit coupled to the calculation module and adapted to complete a plurality of sales records from the aggregated sales information, the plurality of data records corresponding to each inventory item by SKU, sale date, and source-identification; and a data manager coupled to the record composing unit and adapted to store the plurality of sales records.

According to various embodiments, a computer program product for identifying on-shelf availability of inventory items is provided. The computer program product can comprise: computer code for collecting sales information comprising a Stock Keeping Unit SKU), a sale date, and a sale quantity, from at least one source; computer code for aggregating the sales information by calculating one or more measures comprising an expected sales quantity and an out-of-stock measure; computer code for completing a plurality of sales records from the aggregated sales information, the plurality of data records corresponding to each inventory item by SKU, sale date, and source-id; and computer code for storing the plurality of sales records.

According to various embodiments, the computer code for defining a report utilizing a graphical user interface by listing a plurality of available measures prior to end-user reporting, and allowing a user to choose at least one of a plurality of measures.

According to various embodiments, a method for identifying on-shelf availability of an inventory item is provided. The method can comprise: providing a sales record, the sales record comprising a daily sales record for a first date and historical daily sales records for a period of dates prior to said first date, each of the daily sales records comprising a Stock Keeping Unit (SKU), a sale quantity, and a sale date; selecting historical daily sales records having a respective sale date comparable to, but not equal to, the first date and a respective SKU equal to the SKU of the daily sales record; calculating at least one measure based on the selected historical daily sales records, wherein the at least one measure comprises an out-of-stock measure; and reporting the at least one measure.

According to various embodiments, a method for identifying on-shelf availability of an inventory item is provided. The method can comprise: providing a sales record, the sales record comprising a daily sales record for a first date and historical daily sales records for a period of dates prior to said first date, each of the daily sales records comprising a Stock Keeping Unit (SKU), a sale quantity, and a sale date; selecting historical daily sales records having a respective sale date comparable to, but not equal to, the first date and a respective SKU equal to the SKU of the daily sales record; calculating at least one measure based on the selected historical daily sales records, wherein the at least one measure comprises an out-of-stock measure; and reporting the at least one measure.

A method for identifying on-shelf availability of inventory items for at least one store is provided. The method can comprise: providing a sales record, each sales record comprising a sales Stock Keeping Unit (SKU), a sales stored-id, a sales quantity, and a sales date; for each sales record, calculating a set of analogous days of the week for the respective sales date, calculating, based on the set of analogous days of the week, a respective expected sales quantity field; and calculating at least one respective measure, wherein the at least one respective measure comprises an out-of-stock measure; and reporting the at least one respective measure.

Other embodiments of the present teachings will be apparent to those skilled in the art from consideration of the present specification and practice of the present teachings disclosed herein. It is intended that the present specification and examples be considered as exemplary.

What is claimed is:

1. A method for identifying on-shelf availability of inventory items, the method comprising:
collecting sales information comprising a Stock Keeping Unit (SKU), a sale date, and a sale quantity, from one or more sources;
aggregating the sales information by calculating two or more measures comprising at least an expected sales quantity and an out-of-stock measure;
completing a plurality of sales records from the aggregated sales information, the plurality of sales records corresponding to each inventory item by SKU, sale date, and source-identification; and
storing the plurality of sales records.

2. The method of claim 1, wherein the aggregating the sales information by calculating the two or more measures comprises computing at least one of a fixed average, a cumulative average, and a rolling average, based on a time period for which transactional history data is provided by the plurality of sales records.

3. The method of claim 1, wherein the aggregating the sales information by calculating the two or more measures comprises computing a standard deviation based on a day of the week for a time period for which transactional history data is provided by the plurality of sales records.

4. The method of claim 3, where the standard deviation (Δ) is computed by the formula:
Δ=\sqrt{Σ(x−□)²/(n−1)}
where x is a mean daily average, □ is a sample value, and n is a sample size.

5. The method of claim 1, where the two or more measures comprises at least two of Average Daily Sales Value, Average Daily Sales Volume, Count Of Weeks Averaged, Average Weekly Sales Value, Average Weekly Sales Volume, Mean−x% Value, Mean−x% Volume, Standard Deviation Volume, Base Value Sales, Base Volume Sales, Inactive Distribution, Count of Inactive Distribution Week—without ranging data, Count of Inactive Distribution Weeks—with ranging data, Lost Sales Value due to Inactive Distribution, Lost Sales Volume due to Inactive Distribution, Lost Distribution, Count of Lost Distribution Weeks—without ranging data, Count of Lost Distribution Weeks—with ranging data, Lost Sales Value due to Lost Distribution, Lost Sales Volume due to Inactive Distribution, Short Term Offsales, Daily Gunned Offsale Flag, Count of Short Term Offsales (Ungunned), Lost Sales Value due to Short Term Offsales (Ungunned), Lost Sales Volume due to Short Term Offsales (Ungunned), Zero Sales Days (ZSD), Count of ZSDs, Lost Sales Value due to ZSDs, Equivalent Stores ZSD, Other Summary Measures, Sales Lost Out of Stock %, Lost Sales Opportunity, Total Lost Sales Opportunity Value, or a combination thereof.

6. The method of claim 1, wherein the plurality of sales records comprises sales records for 12 weeks or less.

7. The method of claim 1, wherein the plurality of sales records comprises sales records for a year, a quarter of a year, a half of a year, or a month.

8. The method of claim 1, wherein the plurality of sales records comprises sales records for a time period defining a holiday season.

9. The method of claim 1, wherein the plurality of sales records comprises sales records for from about 13 weeks to about 52 weeks.

10. The method of claim 1, wherein the plurality of sales records comprises sales records for more than about 52 weeks.

11. The method of claim 1, wherein each of the plurality of sales records comprises two or more fields and the method further comprises reporting at least one of the plurality of sales records.

12. The method of claim 11, wherein the one or more fields comprises at least one of a sale store-identification, an inventory item manufacturer, an inventory item brand, an inventory item category, an inventory item sub-category, an inventory item sub-sub-category, an inventory item supplier identification, an inventory item brand, an inventory item brand, an inventory item brand, or a combination thereof.

13. The method of claim 11, wherein the reporting comprises using a graphical representation of the one or more fields to formulate a report.

14. The method of claim 11, wherein the reporting comprises selecting a subset of the plurality of sales records.

15. The method of claim 11, wherein the reporting comprises summarizing a subset of the plurality of sales records by aggregating the subset of the plurality of sales record across at least one of the one or more fields.

16. The method of claim 11, wherein the reporting comprises sorting a subset of the plurality of sales records across at least one of the one or more fields.

17. The method of claim 1, wherein storing the plurality of records comprises storing a plurality of transactional records in one or more first set of tables of a database and storing a plurality of reference records in one or more second set of tables of the database.

18. The method of claim 17, wherein each of the plurality of transactional records comprises one or more transaction fields, each of the plurality of reference records comprises one or more reference fields, and the method further comprising:
forming a joint table by obtaining cross-multiplication product of the plurality of transactional records and the plurality of reference records; and
reporting one or more joint table fields of the joint table.

19. The method of claim 1, wherein the one or more sources comprises a manufacturer, a plurality of distribution channels for a manufacturer, a store, a plurality of stores under an umbrella organization, a plurality of stores under a plurality of umbrella organizations, a brand, a plurality of brands, or a combination thereof.

20. The method of claim 1, further comprising managing on-shelf availability of inventory items according to the two or more measures for at least one of the one or more sources.

21. The method of claim 20, wherein managing comprises at least one of performing a root-cause analysis, identifying a SKU specific issue, augmenting inventory of a SKU, recounting inventory of a SKU, adjusting shelf-space of a SKU, or a combination thereof.

22. The method of claim 1, further comprising comparing inventory items sales performance of a test store against a control store wherein the control store comprises a store where no corrective action based on for identifying on-shelf availability of inventory items has been taken and the test store comprises a store where corrective action based on for identifying on-shelf availability of inventory items has been taken.

23. A method for identifying on-shelf availability of inventory items, the method comprising:
collecting sales information comprising a Stock Keeping Unit (SKU), a sale date, and a sale quantity, from at least one source;
aggregating the sales information by calculating two or more measures comprising at least an expected sales quantity and an out-of-stock measure; completing a plurality of sales records from the aggregated sales information, the plurality of sales records corresponding to each inventory item by SKU, sale date, and source-identification, wherein each of the plurality of sales records comprises one or more fields; and
reporting at least one of the plurality of sales records.

24. A system for identifying on-shelf availability of inventory items, the system comprising:
at least one information source module adapted to collect sales information comprising a Stock Keeping Unit (SKU), a sale date, and a sale quantity, from at least one source;
a calculation module coupled to the at least one information source module and adapted to aggregate the sales information by calculating two or more measures comprising at least an expected sales quantity and an out-of-stock measure;
a record composing unit coupled to the calculation module and adapted to complete a plurality of sales records from the aggregated sales information, the plurality of data records corresponding to each inventory item by SKU, sale date, and source-identification; and
a data manager coupled to the record composing unit and adapted to store the plurality of sales records.

25. A computer program product for identifying on-shelf availability of inventory items, the computer program product comprising:
computer code for collecting sales information comprising a Stock Keeping Unit (SKU), a sale date, and a sale quantity, from at least one source;
computer code for aggregating the sales information by calculating two or more measures comprising at least an expected sales quantity and an out-of-stock measure;
computer code for completing a plurality of sales records from the aggregated sales information, the plurality of data records corresponding to each inventory item by SKU, sale date, and source-id; and
computer code for storing the plurality of sales records.

26. The computer program product of claim 25, further comprising computer code adapted to define a report utilizing a graphical user interface by:
listing a plurality of available measures prior to end-user reporting, and
allowing a user to choose at least one of the two or more measures.
